(19) United States
(12) Patent Application Publication
(10) Pub. No.: US 2023/0179121 A1
(43) Pub. Date: Jun. 8, 2023

(54) ELECTROMAGNETIC TRANSDUCER FOR HARVESTING VIBRATORY ENERGY

(71) Applicant: COMMISSARIAT A L'ENERGIE ATOMIQUE ET AUX ENERGIES ALTERNATIVES, Paris (FR)

(72) Inventors: Gallien DELATTRE, GRENOBLE (FR); Sébastien BOISSEAU, GRENOBLE (FR); Sébastien VIGNE, ARPAJON (FR); Alexis BRENES, CHAVILLE (FR)

(21) Appl. No.: 18/073,342

(22) Filed: Dec. 1, 2022

(30) Foreign Application Priority Data
Dec. 2, 2021 (FR) 2112868

(51) Int. Cl. H02N 2/18; H02K 35/02

(52) U.S. Cl. CPC H02N 2/186; H02K 35/02

(57) ABSTRACT

An electromagnetic transducer for harvesting vibratory energy is provided. In particular, an electromagnetic transducer comprising a support, a central mass, and at least one spring linking the central mass to the support, the spring allowing the displacement of the central mass with respect to the support on a first axis. A set of electromagnetic transducers is also provided.

### CROSS-REFERENCE TO RELATED APPLICATION

This application claims priority to foreign French patent application No. FR 2112868, filed on Dec. 2, 2021, the disclosure of which is incorporated by reference in its entirety.

### FIELD OF THE INVENTION

The present invention relates to an electromagnetic transducer for harvesting vibratory energy. In particular, the invention relates to an electromagnetic transducer comprising a support, a central mass, and at least one spring linking the central mass to the support, the spring allowing the displacement of the central mass with respect to the support on a first axis. The present invention relates also to a set of electromagnetic transducers.

### BACKGROUND

The function of vibratory energy harvesters is to electrically power electronic systems from the vibrations that are present in their environment. They require less maintenance and generate less pollution than batteries and are particularly advantageous when the system to be powered is situated in an inaccessible place, without light and adequate thermal gradient. However, the industrialization and the marketing of these vibratory energy harvesters is held in check by their as yet inadequate robustness. Indeed, although many harvesters are theoretically able to supply the power required by their application (powering very low-consumption electronic systems), they are often incapable of adapting to the frequency fluctuations of the actual vibratory sources. In addition, these vibratory energy harvesters are used in environments that are subject to temperature changes although these harvesters are unsuited to such variations. Also, it is difficult for the vibratory energy harvesters to withstand the ageing of their constituent elements. To correct these problems without significantly lowering their power density (as is often the case regarding the strategies based on mechanical adjustment, on multimode systems, or even on non-resonant systems), one of the most promising pathways is electrical adjustment. This method consists in maximizing the transfer of power between the vibratory source and the electrical load, not only at resonance (when the frequency of the vibration coincides with the natural resonance frequency of the mechanical resonator), but also outside of resonance, by means of an impedance matching circuit situated at the electrical load. The result thereof is an increase in effective bandwidth of the harvester, therefore rendering the latter more robust to the actual conditions of use.

The impact of electrical adjustment on the bandwidth depends firstly on the type of transducer providing energy conversion, the type of transducer determining the physical equations governing the behaviour of the harvester. Notably, there are piezoelectric transducers and electromagnetic transducers. Secondly, the electrical adjustment on the bandwidth depends on the characteristic parameters of the harvester such as the mobile mass added to the total volume (effective density of the harvester), the mechanical quality factor, the mechanical resonance frequency, and the coupling. The terms used are piezoelectric coupling in the case of a piezoelectric transducer and electromagnetic coupling in the case of an electromagnetic transducer.

In the case of the piezoelectric transducers, excellent performance levels have already been achieved (bandwidth at −3 dB greater than 10%) by means of strongly-coupled harvesters associated with very efficient extraction circuits. In the case of the electromagnetic transducers, such performance levels are more difficult to achieve because of their electromagnetic coupling which is generally too low. In a condition of small displacement of the mobile mass around an operating point, the derivative of the magnetic flux in the winding with respect to the displacement of the mobile is called the electromagnetic transduction coefficient, and the coupling of an electromagnetic harvester can be defined as the square of this coefficient divided by the internal resistance of the coil and by the total volume of the harvester. In other words, the performance levels of the electromagnetic harvesters are limited by the fact that, for a given displacement of the mobile, the variation of magnetic flux is often too low for the electrical adjustment method to significantly increase the effective bandwidth of the harvester. The performance levels from the electrical adjustment strategy are therefore better for the piezoelectric harvesters.

However, the electromagnetic harvesters offer decisive advantages on other levels such as the technological maturity of the fabrication methods, the cost, the mechanical resistance to impacts and long-term use, etc. This is why the development of harvesters of electromagnetic type remains relevant.

### SUMMARY OF THE INVENTION

The invention aims to mitigate all or some of the problems cited above by proposing an electromagnetic transducer that allows strong coupling, significantly higher than the known electromagnetic harvesters, as well as a high effective density. Thus, the invention aims to achieve better performance levels in terms of bandwidth and of power density with the electrical adjustment method.

The electrical adjustment method is based on the theorem of maximization of the power transfer between any source and any load. According to this theorem, the transferred power is maximal when the impedance of the load is equal to the conjugate complex of the impedance of the source. FIG. 1 represents a generic model 10 describing the behaviour of the electromagnetic transduction harvesters 11 assuming small displacements, associated with an impedance matching circuit 12. The harvester, delivering the voltage v and the current i, is likened to the source while the matching circuit constitutes the load. By appropriately controlling values of the capacitor C_{load} and of the resistor R_{load} according to the input frequency, it is possible to establish the conditions of the theorem at the natural resonance of the harvester, but also outside of resonance.

Some known devices are based on the relative displacement of a magnetic field source with respect to a winding. The displacement, e.g. the translation or the rotation, of a magnetic field created by a magnet drives a variation of the magnetic flux in a winding. To obtain a derivative of the magnetic flux that is the strongest possible with this type of device, it is essential to use a ferromagnetic guide secured to the magnet in order to channel the magnetic field lines at the point through which the coil passes, while reducing the air gap of the magnetic circuit to its strict minimum. This minimal air gap is the thickness of the coil (simply because, if the air gap were less thick than the thickness of the coil, the latter would no longer be able to pass through the assembly composed of the ferromagnetic guide and the magnet). The coil, for its part, must be dimensioned appropriately to maximize the derivative of the magnetic flux within it. Notably a coil that is too thick leads to a derivative of the magnetic flux that is too low even with the ferromagnetic guide. Consequently, a compromise must be found between the thickness of the air gap and that of the coil, and this compromise leads to an electromagnetic that is significantly lower than the electromagnetic coupling that can be achieved with the transducers based on a magnetic field variation (transducers for which the thickness of the air gap is independent of the thickness of the coil). On the other hand, the harvesters based on the relative displacement of a magnetic source with respect to a winding have the advantage of not generating any magnetic force between the mobile and the base of the harvester, this force being the source of difficulties in modelling (complex analytical computation, non-linearity), in design and in fabrication. Notably, there are possibilities of bonding during the phase of assembly or of use, or the generation of dry frictions, etc.

Some harvesters are transducers based on a variation of the form or of the intensity of the magnetic field created by the magnet. These are transducers for which the magnetic flux variation in the winding is provoked by a modification of the magnetic field created by the magnet by means of ferromagnetic elements in motion with respect thereto. The displacement of a mobile provokes a variation of the thickness of the air gaps, i.e. distance separating the mobile from the rest of the ferromagnetic guide containing the magnets. This air gap variation leads to a variation of the reluctance of the magnetic circuit supplied by the magnets, such that the flux picked up by the coil is maximal when the mobile is in a position such that the air gap is small, and minimal such that the air gap is high. However, such devices require particular attention concerning the magnetic force, because the latter can generate bonding or dry friction if no provision is made during the design of the harvester.

The invention aims to mitigate the problems cited previously by proposing an electromagnetic transducer that is significantly less subject to bonding or dry friction and which is particularly compact.

To this end, the subject of the invention is an electromagnetic transducer comprising a support, a central mass, and at least one spring linking the central mass to the support, the spring allowing the displacement of the central mass with respect to the support on a first axis; the central mass comprising a central ferromagnetic element, a first magnet, a second magnet, and two additional ferromagnetic elements, the ferromagnetic element being flanked on a first side on the first axis by the first magnet and flanked on a second side, opposite the first side on the first axis, by the second magnet, the first magnet and the second magnet being each flanked on the first axis by one of the additional ferromagnetic elements; the support surrounding the central mass radially to the first axis and an air gap separating the support from the central mass, the support comprising at least one coil wound around the first axis and secured to an outer ferromagnetic element; the electromagnetic transducer being configured in such a way that the magnetic flux from the first magnet and the magnetic flux from the second magnet each follow one path out of a first path and a second path, the first path not passing through the coil, the second path passing through the coil and continuing around the coil via the outer ferromagnetic element: the displacement of the central mass on the first axis driving the modification of the path of at least one of the magnetic fluxes from the first path to the second path or vice versa.

“The spring allowing the displacement of the central mass with respect to the support on a first axis” is understood to mean that the spring is capable of being deformed in response to a vibration, its deformation driving a displacement of the central mass on a first axis.

“Flanked on a first side on the first axis and flanked on a second side, opposite the first side on the first axis, by a second magnet, the first magnet and the second magnet being each flanked on the first axis by an additional ferromagnetic element” is understood to mean that the central ferromagnetic element, the first magnet, the second magnet and the additional ferromagnetic elements are stacked axially.

“The support surrounding the central mass radially to the first axis and an air gap separating the support from the central mass” is understood to mean that the support is disposed around and at a distance from the central mass. This distance is large enough for vibrations which would drive the movement of the central mass not to cause frictions between the central mass and the support. This air gap or this distance depends essentially on the difference in stiffness between the radial magnetic force tending to move the mass away from its translation axis, and the radial mechanical force linked to the springs tending to compensate the magnetic stiffness and return the mass to its translation axis. If this difference is positive, then it is necessary either to increase the radial stiffness of the springs if that is possible or else to increase the air gap concerned in order to reduce the magnetic stiffness. The air gap is a function of the dimensions of the central mass and must be assessed according to the technical tolerance margin of its fabrication method and according to a thermal expansion tolerance according to the environment of use.

“A coil wound around the axis” is understood to mean that the coil is disposed radially to the first axis.

“The magnetic flux from the first magnet and the magnetic flux from the second magnet each follow one path” is understood to mean that the spatial distribution of the magnetic field and notably most of the magnetic field lines are guided along a specific path.

In “the first path not passing through the coil” and “the second path passing through the coil and continuing around the coil”, “pass through the coil” is understood to mean that the magnetic field lines are guided so as to pass through the radial plane in which the coil is disposed with respect to the first axis. “Around the coil” is understood to mean that the magnetic field lines are guided to form a loop going from one pole to the other of one and the same magnet, the loop winding around the coil.

The electromagnetic transducer of the present invention therefore combines (i) the relative displacement of a magnetic source, here the central mass comprising a first magnet and a second magnet, with respect to a winding, here the support comprising the wound coil and (ii) a variation of the magnetic field created by the magnets of the central mass according to the ferromagnetic elements which are in motion (ferromagnetic elements included in the central mass) or not (ferromagnetic elements included in the support). Furthermore, the electromagnetic transducer of the present invention comprises an air gap that is reduced to the minimum, the air gap being only large enough to separate the support from the central mass and allow the central mass to move with respect to the support. These advantages allow a considerable improvement of the effective density of the electromagnetic transducer and of the mechanical quality factor and of the coupling. Also, the ferromagnetic elements make it possible to increase the derivative of the magnetic flux with respect to the displacement of the central mass as well as the transduction coefficient.

According to the present invention, the coil is situated on the support which, when the electromagnetic transducer is in use, is fixed. Thus, the coil does not undergo the movement of the central mass and the risk of breakage by repetitive movement is reduced. Also, the electromagnetic transducer of the present invention is adapted for the central mass to occupy a maximal volume in the electromagnetic transducer, which makes it possible to maximize the effective density and the electromagnetic coupling.

Furthermore, the electromagnetic transducer of the present invention can be produced by using magnets of standard form and magnetization, reducing the fabrication or assembly costs and the potential maintenance costs.

Furthermore, the electromagnetic transducer allows a displacement of the central mass which is limited only on the first axis and by the spring, no other element in the electromagnetic transducer limiting the travel of the central mass. Thus, the dimensioning of the electromagnetic transducer of the present invention is simple and independent of the displacement of the central mass.

Advantageously, the spring of the electromagnetic transducer of the invention comprises a first spring fixed onto an outer face of one of the additional ferromagnetic elements and a second spring fixed onto an outer face of the other additional ferromagnetic element.

Advantageously, the spring of the electromagnetic transducer of the invention comprises at least one flat spring extending primarily in a plane at right angles to the first axis, preferably being a three-branch spiral spring.

Advantageously, the coil of the electromagnetic transducer of the invention is entirely embedded in the outer ferromagnetic element.

Advantageously, the central mass of the electromagnetic transducer of the invention is flanked on at least one side on the first axis by a third magnet and an additional ferromagnetic element.

Advantageously, the support of the electromagnetic transducer of the invention comprises several coils.

Advantageously, the axes of the poles of the first magnet and of the second magnet of the electromagnetic transducer of the invention are reversed on the first axis.

Advantageously, the central mass of the electromagnetic transducer of the invention is cylindrical.

Advantageously, the electromagnetic transducer of the invention further comprises a protection of the coil.

The invention relates also to a set of electromagnetic transducers as described previously, the coils of the electromagnetic transducers being linked to one another in parallel and/or in series.

### BRIEF DESCRIPTION OF THE DRAWINGS

Other features, details and advantages of the invention will emerge on reading the description given in reference to the attached drawing, which is given by way of example and in which:

FIG. 1 represents a model describing the generic model behaviour of electromagnetic transduction harvesters assuming small displacements, associated with an impedance matching circuit.

FIG. 2 schematically represents an electromagnetic transducer whose central mass is in a position of equilibrium.

FIG. 3 schematically represents an electromagnetic transducer whose central mass is displaced with respect to the position of equilibrium and on a first axis.

FIG. 4 schematically represents an electromagnetic transducer whose central mass is displaced with respect to the position of equilibrium, on a first axis and the reverse of the displacement of the central mass in FIG. 3.

FIG. 5a represents a flat spiral spring with three branches 0.5 mm thick.

FIG. 5b represents a flat spiral spring with three branches 1 mm thick.

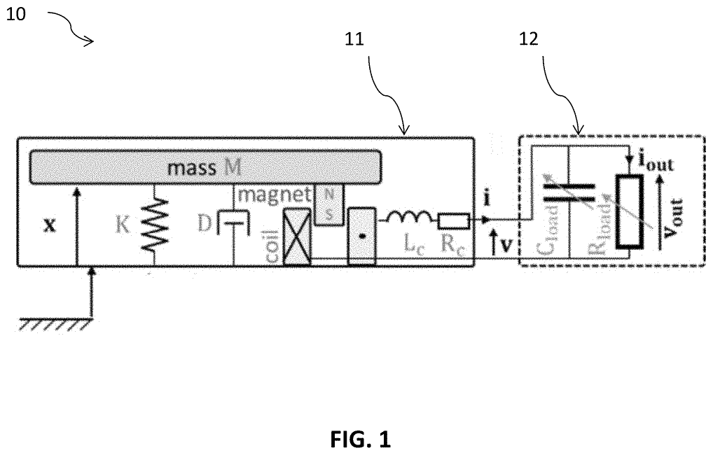

### DETAILED DESCRIPTION

Preferentially, the electromagnetic transducer of the present invention has an essentially axisymmetrical structure that can be contained in a simple volume such as a cylinder. This notably makes it possible to minimize the edge effects of the magnetic field, to minimize the volume lost by its packaging and to facilitate its incorporation in a generic context. Furthermore, the essentially axisymmetrical structure of the electromagnetic transducer of the present invention makes it possible to speed up the convergence of the EMF simulations necessary to its dimensioning.

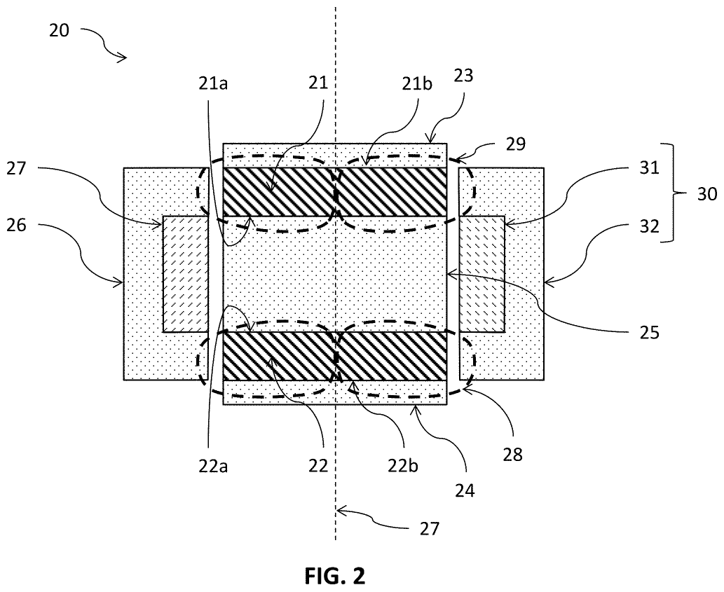

FIG. 2 represents an electromagnetic transducer 20 according to the invention, it being notably in a position of equilibrium, of rest, that is to say the position at which the central mass is situated when no vibration affects the electromagnetic transducer. The electromagnetic transducer 20 comprises a central ferromagnetic element 25 flanked on a first side on the first axis 27 by a first magnet 21 having a face 21a opposite the central ferromagnetic element 25 and an opposite face 21b. This first magnet 21 is flanked on the first axis 27 and opposite its opposite face 21b by an additional ferromagnetic element 23. The ferromagnetic element 25 is flanked on a second side on the first axis 27 and opposite the first side by a second magnet 22 having a face 22a opposite the central ferromagnetic element 25 and an opposite face 22b. This second magnet 22 is flanked on the first axis 27 and opposite its opposite face 22b by an additional ferromagnetic element 24. The first magnet and the second magnet are disposed in such a way that the opposite faces on the first axis each constitute a pole, that is to say that the face 21a corresponds to the north or south pole while the face 21b corresponds to the opposite pole, and likewise for the faces 22a and 22b.

Preferentially, the elements forming the central mass, that is to say the central ferromagnetic element 25, the first magnet 21, the second magnet 22 and the additional ferromagnetic elements 23, 24 are cylinders, preferably cylinders of revolution.

The electromagnetic transducer 20 also comprises a support 30 surrounding the central mass radially to the first axis and an air gap separating the support 30 from the central mass. The support 30 comprises a coil 31 wound around the first axis and secured to an outer ferromagnetic element 32. The outer ferromagnetic element 32 is notably made of a single block. Indeed, when the outer ferromagnetic element 32 is made in several parts, the presence of joins between its parts can disturb the magnetic fluxes 28, 29. When the coil 31 is closed at least partially in the outer ferromagnetic element 32, that is to say that each of its faces is at least partially covered by a part of the outer ferromagnetic element 32, the latter must then be in several parts. The outer ferromagnetic element 32 can notably comprise an open recess on the central mass 21 into which the coil 31 is inserted, as represented. The coil 31 can notably be flush with the surface of the outer ferromagnetic element 32 or else set back from the surface thereof. In particular, the coil is dimensioned to be set back from the surface thereof, which limits the functional plays. In particular, the recess is configured for the coil 31 to be disposed opposite only the central ferromagnetic element 25 in the position of equilibrium of the electromagnetic transducer 20, as represented. Thus, in an advantageous embodiment, the height of the coil 31 is less than or equal to that of the central ferromagnetic element 25. The path of the magnetic fluxes 28, 29 from the magnets 21, 22 is not therefore influenced by the coil 31 in the position of equilibrium of the electromagnetic transducer 20. It is not then necessary to cover the coil 31 partially on the face opposite the central mass 21 by a ferromagnetic element, this covering being produced in order to avoid a modification of the magnetic flux 28, 29 from the first and second magnets 21, 22 in the position of equilibrium. Thus, advantageously, since the coil 31 is not covered on its face opposite the central mass 21, and the air gap separating these two elements is consequently smaller than with a cover, the electromagnetic transducer 20 is more compact. Because of this smaller air gap, as is described in detail hereinbelow, the transition of the magnetic fluxes 28, 29 from a short path (in which they do not pass through the coil 31) to a long path (in which they pass through the coil 31) is easier and therefore the electromagnetic transducer 20 is more efficient. In the particular embodiment of FIG. 2, the coil 31 is situated radially closest to the central mass and the outer ferromagnetic element surrounds the coil radially and on the first axis, that is to say that only a central part of the face of the support 30 radially closest to the central mass includes the coil.

In the invention, the coil 31 advantageously acts both as current generator, through the modification of the path of the magnetic fluxes 28, 29, and as insulator, which makes it possible to reduce the air gap separating the central mass 21 from the coil 31 and therefore obtain a compact electromagnetic transducer 20.

The magnetic flux 29 from the first magnet 21 describes a loop going from one pole thereof to another, that is to say from a face 21a to a face 21b or vice versa, and guided by the central ferromagnetic element 25, the outer ferromagnetic element 32 and the additional ferromagnetic element 23. The magnetic flux 29 does not pass through the coil 31. The magnetic flux 28 from the second magnet 22 describes a loop going from one pole thereof to another, that is to say from a face 22a to a face 22b or vice versa, and guided by the central ferromagnetic element 25, the outer ferromagnetic element 32 and the additional ferromagnetic element 24. The magnetic flux 28 does not pass through the coil 31.

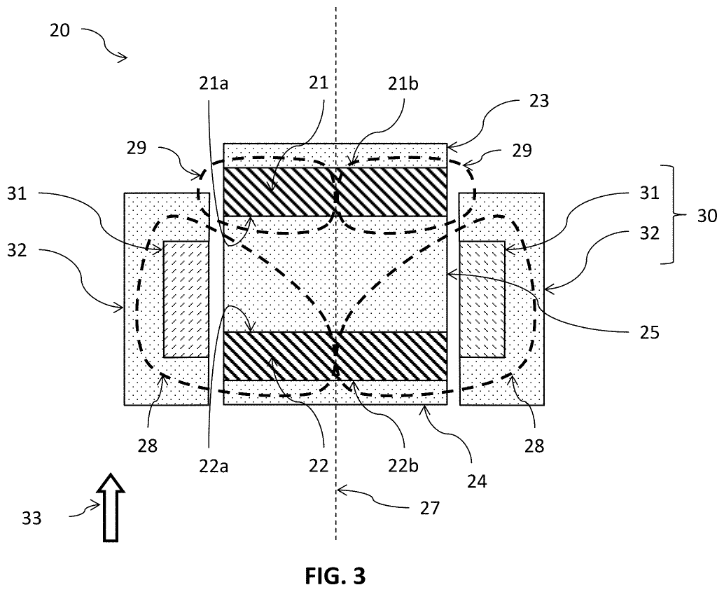

FIG. 3 represents an electromagnetic transducer 20 similar to the electromagnetic transducer of FIG. 2 but whose central mass is not in a position of rest. Following a vibration, the spring was able to be deformed and the central mass was displaced with respect to the support on the first axis 27 and in the direction 33. Upon this vibration, the displacement of the central mass drives a modification of at least one of the paths followed by the magnetic flux from one of the magnets with respect to the coil 31. Thus, the coil 31 is at least partially opposite the first magnet 21 or the second magnet 22 which influences the path of the corresponding magnetic flux 28, 29. In FIG. 3, the coil 31 is partially opposite the second magnet 22 and the magnetic flux 28 from the second magnet 22 is modified and passes through the coil 31, continuing around the coil 31, guided by the central ferromagnetic element 25, the outer ferromagnetic element 32 and the additional ferromagnetic element 24. The modification of the path of the magnetic flux 28 drives an increase in the electromagnetic coupling and therefore increases the effective bandwidth of the electromagnetic transducer, provided that the latter is associated with an impedance matching circuit.

Following this displacement of the central mass on the first axis 27 with respect to the support 30 and in a direction 33, the central mass will be displaced in the direction of the first axis 27 by an oscillation movement about its position of equilibrium, which will once again cause modification of the path of the magnetic flux 28 to the short path in as much as the coil 31 will no longer be opposite the second magnet 22, and, if the displacement of the central mass is sufficient, will drive the coil 31 opposite the first magnet 21 and modify the path of the magnetic flux 29 from the first magnet in such a way that it passes through the coil 31.

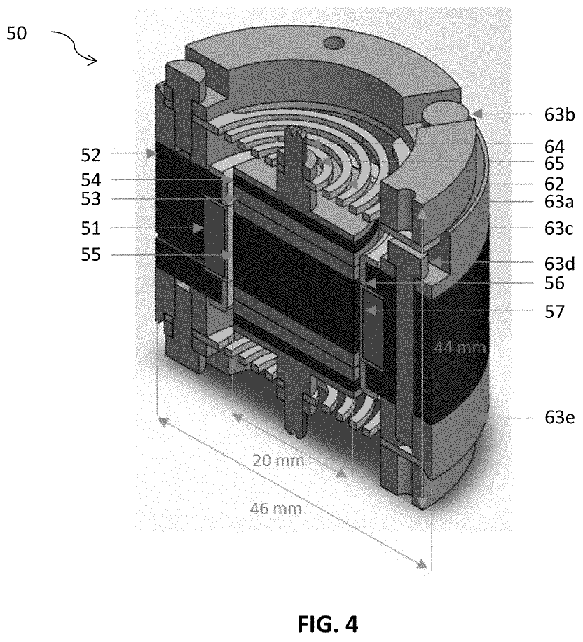

FIG. 4 represents an electromagnetic transducer 50 comprising a coil 51, an outer ferromagnetic element 52, a first magnet 53, an additional ferromagnetic element 54 and a central ferromagnetic element 55. The electromagnetic transducer 50 comprises in particular a protection 56 made of non-ferromagnetic material which limits the risk of bonding between the central mass and the outer ferromagnetic element 52. The electromagnetic transducer 50 comprises a flat spring 62 with three branches which links the support to the central mass via an attachment 64 and a nut 65. The attachment 64 is linked to the central mass by a bonding of an end of the attachment in disc form to the central mass. The other opposite end of the attachment on the axis can comprise a threaded rod making it possible to compress the spring between the attachment 64 and the nut 62. The support comprises in particular a ring 63c and a ring 63e which hold the outer ferromagnetic element 52 by means of a screw 63d. The spring 62 is linked to the support by being compressed between a ring 63a and the ring 63c by means of a screw 63b.

The electromagnetic transducer 50 according to FIG. 4 comprises a coil support 57 facilitating the fabrication and the linking of the coil 51 with the outer ferromagnetic element 52. Such a coil support 57 can be used in other embodiments of the invention and is not particularly linked to the embodiment of FIG. 4. Notably, the coil support 57 is optionally linked to the protection 56.

The electromagnetic transducer 50 according to FIG. 4 is an example of electromagnetic transducer according to the present invention and does not limit the invention to this example. Notably, other linking means between the central mass and the support can be used. Also, the support can be linked to the support or to the central mass by other means, for example by welding, bonding or snap-fitting.

The dimensions indicated in FIG. 4, notably a total height of 44 mm, a total width of 46 mm and a width of the central mass of 20 mm are given as an indication and an electromagnetic transducer according to the invention can have other dimensions.

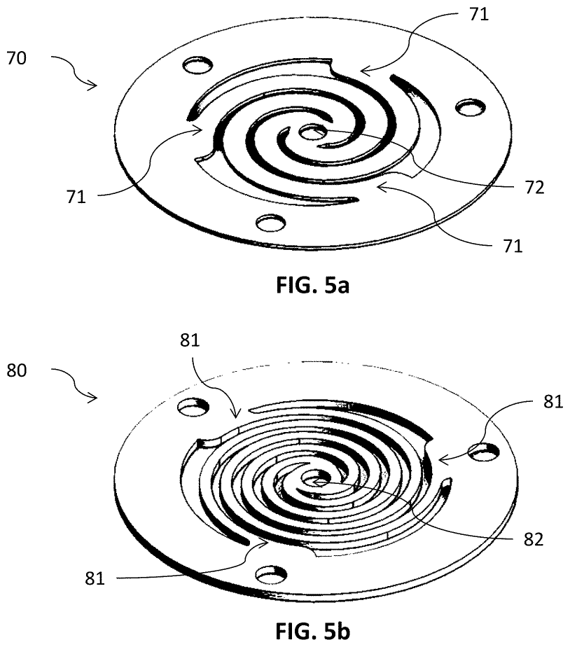

FIGS. 5a and 5b each represent a flat spiral spring with three branches, forming a disc extending radially about an axis passing through the middle of each spring. The flat spring 70 of FIG. 5a comprises three branches 71, the branches forming spirals towards the middle 72 of the spring 70. The branches 71 of the spring 70 describe approximately one turn about the axis passing through the middle 72 between the outside and the inside of the spring with respect to the axis. According to EMF simulations, the flat spiral spring with three branches of FIG. 5a with a thickness of 0.5 mm would have an axial stiffness of approximately 16.8 N/mm and a radial stiffness of 803 N/mm. The flat spring 80 of FIG. 5b comprises three branches 81, the branches forming spirals towards the middle 82 of the spring 80. The branches 81 of the spring 80 describe approximately one and a half turns about the axis passing through the middle 82 between the outside and the inside of the spring with respect to the axis. The branches 81 of the spring 80 are thinner radially at the axis. The thickness of the spring 70 is less than the thickness of the spring 80. According to EMF simulations, the flat spring with three branches of FIG. 5b with a thickness of 1 mm would have an axial stiffness of approximately 16.8 N/mm and a radial stiffness of 57 N/mm.

The springs 70, 80 of FIGS. 5a and 5b are examples of spring that the electromagnetic transducer of the invention can include. However, other springs, and particularly other flat springs, can be used to implement the invention. The person skilled in the art would be able to adapt the thickness of the flat spring, the number of branches, the number of turns that the branches describe between the outside and the inside of the spring with respect to the axis and the material or materials of the springs according to the environment in which the electromagnetic transducer is to be used and according to the dimensional constraints.

The flat spiral springs with three branches that are present can be dimensioned so as to have an axial stiffness that is low enough for the natural resonance frequency to be close to 50 Hz. On the other hand, the radial stiffness of such flat springs is strong enough to guide the central mass along the first axis without the central mass and the support coming into physical contact, that is to say without bonding.

Assuming a quality factor of an electromagnetic transducer according to the present invention of 100, a resonance frequency of 50 Hz and that this electromagnetic transducer is subjected to a vibration whose acceleration amplitude is equivalent to 0.5 m/s² while the frequency is defined over a range centred around 50 Hz, an estimation of the harvestable power can be obtained. By taking the example of a volume of the smallest cylinder that can contain the electromagnetic transducer that is 73 cm², the maximum normalized power density would be of the order of 28 kg·s/m³. According to this example, the effective bandwidth at −3 dB would be equivalent to 4.2 Hz.

Different electromagnetic transducers presented here can be used in groups rather than individually, so as to form a set. It is not therefore necessary for these electromagnetic transducers to be identical and electromagnetic transducers according to different embodiments presented here can be used together without limitation. They can notably be disposed in series or in parallel. In particular, the coils of the electromagnetic transducers of one and the same set can be linked in series and/or in parallel.

The different embodiments presented in this description are not limiting and can be combined with one another. Furthermore, the present invention is not limited to the embodiments previously described, but extends to any embodiment falling within the scope of the claims. CLAIMS

1. An electromagnetic transducer comprising a support, a central mass, and at least one spring linking the central mass to the support, the spring allowing the displacement of the central mass with respect to the support on a first axis,
the central mass comprising a central ferromagnetic element, a first magnet, a second magnet, and two additional ferromagnetic elements, the ferromagnetic element being flanked on a first side on the first axis by the first magnet and flanked on a second side, opposite the first side on the first axis, by the second magnet, the first magnet and the second magnet being each flanked on the first axis by one of the additional ferromagnetic elements,
the support surrounding the central mass radially to the first axis and an air gap separating the support from the central mass, the support comprising at least one coil wound around the first axis and secured to an outer ferromagnetic element,
the electromagnetic transducer being configured in such a way that the magnetic flux from the first magnet and the magnetic flux from the second magnet each follow one path out of a first path and a second path, the first path not passing through the coil, the second path passing through the coil and continuing around the coil via the outer ferromagnetic element,
the displacement of the central mass on the first axis driving the modification of the path of at least one of the magnetic fluxes from the first path to the second path or vice versa.

2. The electromagnetic transducer according to claim 1, the spring comprising a first spring fixed onto an outer face of one of the additional ferromagnetic elements and a second spring fixed onto an outer face of the other additional ferromagnetic element.

3. The electromagnetic transducer according to claim 1, the spring comprising at least one flat spring extending primarily in a plane at right angles to the first axis, preferably being a three-branch spiral spring.

4. The electromagnetic transducer according to claim 1, the coil being entirely embedded in the outer ferromagnetic element.

5. The electromagnetic transducer according to claim 1, the central mass being flanked on at least one side on the first axis by a third magnet and an additional ferromagnetic element.

6. The electromagnetic transducer according to claim 5, the support comprising several coils.

7. The electromagnetic transducer according to claim 1, the axes of the poles of the first magnet and of the second magnet being reversed on the first axis.

8. The electromagnetic transducer according to claim 1, the central mass being cylindrical.

9. The electromagnetic transducer according to claim 1, further comprising a protection of the coil.

10. A set of electromagnetic transducers according to claim 1, the coils of the electromagnetic transducers being linked to one another in parallel and/or in series.
